(19) United States
(12) Patent Application Publication
(10) Pub. No.: US 2024/0427957 A1
(43) Pub. Date: Dec. 26, 2024

(54) METHOD AND SYSTEM FOR DETERMINING STRETCHING AND/OR WRINKLING FAILURE

(71) Applicant: GM GLOBAL TECHNOLOGY OPERATIONS LLC, Detroit, MI (US)

(72) Inventors: Ziqiang Sheng, Troy, MI (US); Timothy J Byrd, Goodrich, MI (US); Ronald Schabel, Lapeer, MI (US); Kleber M Cabral, Auburn Hills, MI (US); Michael J Watson, Grand Blanc, MI (US)

(73) Assignee: GM GLOBAL TECHNOLOGY OPERATIONS LLC, Detroit, MI (US)

(21) Appl. No.: 18/339,803

(22) Filed: Jun. 22, 2023

(51) Int. Cl. G06F 30/20; G06F 30/15

(52) U.S. Cl. CPC G06F 30/20; G06F 30/15; G06F 2113/24; G06F 2119/02; G06F 2119/14

(57) ABSTRACT

Methods and systems for analyzing stamped parts having a final shape for a vehicle are provided. A method includes receiving data for the stamped part; producing a computer simulation based on the data; determining a wrinkling index (WI) for the stamped part in response to the processor producing the computer simulation; determining whether an element under analysis is located at a trimmed edge of the stamped part; when the element under analysis is located at a trimmed edge of the stamped part, determining a stretching index (SI) for a trimmed edge portion, or when the element under analysis is not located at a trimmed edge of the stamped part, determining a SI for a plane stress portion in response to the processor producing the computer simulation; comparing the SI to a SI threshold and/or comparing the SI to the WI; and generating, using the processor, a uniform failure index (UFI).

### INTRODUCTION

The present disclosure generally relates to stamping die development, and more particularly relates to consolidating stretching-based fracture failures and geometry-based wrinkling failures into one failure detection.

Automotive manufacturers continuously investigate improvements of manufacturing processes for automotive vehicle components. As one example, stamping is a manufacturing process for producing sheet metal components. During the stamping process, a die and a binder ring coordinate with one another to hold a piece of sheet metal or so-called blank in a fixed position. The die includes a die cavity, and a punch draws the sheet metal into the die cavity to form a workpiece having a desired shape associated with the die cavity. The binder ring includes beads for engaging the sheet metal and controlling an amount of sheet metal flowing into the die cavity. Insufficient sheet metal flow causes stretching failure, such as fracture, while excessive amount metal flow causes wrinkling.

A workpiece such as a stamped sheet may exhibit a variety of failures. For example, stretching-based fracture failures may be located within the sheet, stretching-based fracture failures may be located at a trimmed edge of the sheet, and geometry-based wrinkling failures may be located on the sheet. In industrial practices, technicians manually execute multiple methods with associated criteria independent from one another for identifying failures in the different portions of the workpiece. This process can introduce complexity and uncertainties into failure detection, which can in turn lower the efficiency of developing stamping die.

Thus, while existing methods and systems of developing stamping die achieve their intended purpose, there is a need for a new and improved method and system for developing stamping die that address these issues.

### SUMMARY

A method is provided for analyzing a stamped part that has a final shape for a motor vehicle and includes receiving, using the processor, data for the stamped part: producing, using the processor, a computer simulation based on the data: determining, using the processor, a wrinkling index (WI) for the stamped part in response to the processor producing the computer simulation: determining, using the processor, whether an element under analysis is located at a trimmed edge of the stamped part: when the element under analysis is located at a trimmed edge of the stamped part, determining, using the processor, a stretching index (SI) for a trimmed edge portion in response to the processor producing the computer simulation, or when the element under analysis is not located at a trimmed edge of the stamped part, determining, using the processor, a SI for a plane stress portion in response to the processor producing the computer simulation: comparing the SI to a SI threshold and/or comparing the SI to the WI; and generating, using the processor, a uniform failure index (UFI) equal to the SI in response to the processor determining that the SI is greater than the SI threshold, a UFI equal to the SI in response to the processor determining that the SI is not greater than the SI threshold and is greater than the absolute value of the WI, and a UFI equal to the WI in response to the processor determining that the SI is not greater than the SI threshold and is not greater than the absolute value of the WI.

In some embodiments, the method further includes generating, using the processor, a stretching failure signal in response to the processor determining that the SI is greater than the SI threshold; and indicating, using the display device, that the stamped part has a fracture in response to the display device receiving the stretching failure signal.

In some embodiments, the method further includes generating, using the processor, a wrinkling failure signal in response to the processor determining that the WI is less than a WI threshold; and indicating, using the display device, that the stamped part has a wrinkle in response to the display device receiving the wrinkling failure signal.

In some embodiments, the method further includes generating, using the processor, a stretching failure signal in response to the processor determining that the SI is greater than the stretching index threshold: otherwise generating, using the processor, a wrinkling failure signal in response to the processor determining that the absolute WI value is less than a WI threshold; and indicating, using the display device, that the stamped part has a fracture in response to the display device receiving the stretching failure signal and that the stamped part has a wrinkle in response to the display device receiving the wrinkling failure signal.

In some embodiments of the method, the SI threshold is 1 and the WI threshold is-1.

In some embodiments of the method, determining, using the processor, whether the element under analysis is located at a trimmed edge of the stamped part is performed using the following evaluation:
assuming linear strain path at each operation, which is true for most stamping operations, calculating, for each element, ratio between incremental minor strain and major strain at each time step i of operation p according to equation (3.1):

$${ρ}^{p} ( i ) = \frac{d {ε}_{2}^{p} ( i )}{d {ε}_{1}^{p} ( i )} \qquad ( 3.1 )$$

where, dε₂^{p}(i) and dε₁^{p}(i) are incremental minor strain and major strain calculated according to equation (3.2):

$$d {ε}_{j}^{p} ( i ) = {ε}_{j}^{p} ( i ) - {ε}_{j}^{p} ( 0 ) , j = 1 , 2 \qquad ( 3.2 )$$

where, using a normal anisotropy parameter

$$\overline{r} = \frac{{r}_{0} + 2 {r}_{45} + {r}_{90}}{4} ,$$

under uniaxial tension, the critical strain ratio ρ^{u}, is about

$$\frac{- \overline{r}}{\overline{r} + 1} [ 2 ] ,$$

and the element under analysis is determined to be at a trimmed edge of the stamped part according to equation (3.3):

$$0.9 {ρ}^{u} \leq {ρ}^{p} ( i ) \leq 1.1 {ρ}^{u} . \qquad ( 3.3 )$$

This method can work with other method to determine the trimmed edge, for example checking if the element has a free edge.

In some embodiments of the method, determining, using the processor, a SI for a trimmed edge portion in response to the processor producing the computer simulation includes determining a maximum SI from a plurality of stretching indices.

In some embodiments of the method, determining, using the processor, a SI for a plane stress portion in response to the processor producing the computer simulation includes determining the SI from the equation (1.1):

$$SI = max ( \frac{{ε}_{1}^{p} ( i )}{{ε}_{1}^{F} ( {ε}_{2}^{p} ( i ) )} , \frac{{th}^{p} ( i )}{{th}^{M} ( {ε}_{2}^{p} ( i ) )} ) , within sheet panel . \qquad ( 1.1 )$$

In some embodiments of the method, determining, using the processor, a SI for a trimmed edge portion in response to the processor producing the computer simulation includes determining the SI from the equation (1.2):

$$SI = max ( \frac{{ε}_{1}^{p *} ( i )}{{ε}_{1}^{E}} , \frac{{ε}_{1}^{p} ( i )}{{ε}_{1}^{F} ( {ε}_{2}^{p} ( i ) )} , \frac{t {h}^{p} ( i )}{t {h}^{M} ( {ε}_{2}^{p} ( i ) )} ) , on trimmed edge . \qquad ( 1.2 )$$

In some embodiments of the method, determining, using the processor, a SI for a plane stress portion in response to the processor producing the computer simulation includes determining a maximum SI from a plurality of stretching indices.

In some embodiments of the method, determining, using the processor, the WI for the stamped part in response to the processor producing the computer simulation includes determining the WI from the equation (1.3):

$$W I = - \frac{w}{{w}_{C}} , \qquad ( 1.3 )$$

In some embodiments, the method further includes displaying visual indications of the stretching indexes and wrinkling indexes associated with the computer simulation.

A system is provided for analyzing a stamped part that has a final shape for a motor vehicle and includes a processor configured to: receive, data for the stamped part: produce a computer simulation based on the data: determine a WI for the stamped part in response to the processor producing the computer simulation: determine whether an element under analysis is located at a trimmed edge of the stamped part: determine a SI for a trimmed edge portion when the element under analysis is located at a trimmed edge of the stamped part; determine a SI for a plane stress portion when the element under analysis is not located at a trimmed edge of the stamped part: compare the SI to a SI threshold and/or compare the SI to the WI; and generate a uniform failure index (UFI) equal to the SI in response to determining that the SI is greater than the index threshold, a UFI equal to the SI in response to determining that the SI is not greater than the stretching index threshold and is greater than the absolute value of the WI, and a UFI equal to the WI in response to determining that the SI is not greater than the SI threshold and is not greater than the absolute value of the WI; and a display device electrically coupled to the processor and configured to visually indicate the stretching indexes and the wrinkling indexes associated with the computer simulation.

In some embodiments of the system, the processor is configured to generate a stretching failure signal in response to determining that the SI is greater than the SI threshold; and the display device is configured to indicate the stamped part has a fracture in response to the display device receiving the stretching failure signal.

In some embodiments of the system, the processor is configured to generate a wrinkling failure signal in response to the processor determining that the WI is less than a WI threshold; and the display device is configured to indicate the stamped part has a wrinkle in response to the display device receiving the wrinkling failure signal.

In some embodiments of the system, the processor is configured to generate a stretching failure signal in response to determining that the SI is greater than the SI threshold; the processor is configured to generate a wrinkling failure signal in response to the processor determining that the WI is less than a WI threshold; and the display device is configured to indicate the stamped part has a fracture in response to the display device receiving the stretching failure signal; and the display device is configured to indicate the stamped part has a wrinkle in response to the display device receiving the wrinkling failure signal.

A system is provided for producing a die configured to form a sheet metal blank into a workpiece for a stamped part that has a final shape for a motor vehicle, with the workpiece having a bead affect portion, a trimmed edge portion, and a plane stress portion, the system including: a processor configured to: receive data for at least one of a die design, a part design, and a stamping process plan associated with the workpiece: produce a computer simulation based on the data: determine a SI for an associated one of the bead affect portion, the trimmed edge portion, and the plane stress portion of the workpiece in response to the processor producing the computer simulation: compare the SI for each of the bead affect portion, the trimmed edge portion, and the plane stress portion to an SI threshold; and generate a stretching failure signal in response to the processor determining that the SI for at least one of the bead affect portion, the trimmed edge portion, and the plane stress portion is greater than the stretching index threshold: determine a WI for the workpiece in response to the processor producing the computer simulation: compare the WI to a WI threshold; and generate a wrinkling failure signal in response to the processor determining that the WI is less than the wrinkling index threshold, i.e., when (WI≤−1), wrinkling is reported: receive altered data for at least one of an altered die design, an altered part design, and an altered stamping process plan associated with the workpiece: produce an altered computer simulation based on the altered data: determine an altered SI for an associated one of the bead affect portion, the trimmed edge portion, and the plane stress portion of the workpiece in response to the processor producing the altered computer simulation; and generate a stretching acceptance signal in response to the processor determining that one of the SI and the altered SI for each of the bead affect portion, the trimmed edge portion, and the plane stress portion is less than the SI threshold: determine an altered WI for the workpiece in response to the processor producing the altered computer simulation; and generate a wrinkling acceptance signal in response to the processor determining that the altered WI is within the wrinkling index threshold i.e., when the altered WI>−1; and a display device electrically coupled to the processor and configured to: indicate that the workpiece has a fracture and/or a wrinkle and to prompt a user to input the altered data into the processor, in response to the display device receiving the stretching failure signal and/or the wrinkling failure signal: indicate that the workpiece does not have the fracture and/or the wrinkle in response to the display device receiving the stretching acceptance signal and/or the wrinkling acceptance signal, such that the processor sends the stretching acceptance signal and/or the wrinkling acceptance signal to a die manufacturing device for transforming a tool material into the die associated with one of the SI and the altered SI to be less than the stretching index threshold and with one of the WI and the altered WI to be greater than the WI threshold.

In some embodiments of the system, the processor is configured to receive the data associated with the part design, with the data including at least one of a geometry of the stamped part and at least one material property of the sheet metal forming the stamped part.

In some embodiments of the system, the processor is configured to generate a bead affect stretching failure signal in response to the processor determining that the SI of the bead affect portion is greater than the stretching index threshold, and the display device indicates that the fracture is disposed in the bead affect portion in response to the display device receiving the bead affect stretching failure signal from the processor.

In some embodiments of the system, the processor is configured to generate a trimmed edge stretching failure signal in response to the processor determining that the SI of the trimmed edge portion is greater than the stretching index threshold, and the display device indicates that the fracture is disposed in the trimmed edge portion in response to the display device receiving the trimmed edge stretching failure signal from the processor.

### DESCRIPTION OF THE DRAWINGS

The present disclosure will hereinafter be described in conjunction with the following drawing figures, wherein like numerals denote like elements, and wherein:

FIG. 1 is a schematic diagram of one example of a system for producing a die of a stamping machine that forms a sheet metal blank into a stamped part of a motor vehicle.

FIG. 2 is an enlarged view of the stamping machine illustrated in FIG. 1.

FIG. 3 is a schematic illustrating a wrinkling risk calculation.

FIG. 4 is a flowchart of an example of a method for operating the system of FIG. 1.

FIG. 5 is a flowchart of an example of a method for operating the system of FIG. 1.

FIG. 6 is a flowchart of an example of a method of using UFI to optimize a stamping process.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

An exemplary system and method of reporting stretching failure in stamping die development consolidates three criteria and processes for detecting three different types of stretching failures into one stretching index (SI) representation. Examples of the stretching failures include a trimmed edge fracture, a localized necking and following fracture at bead affect zone, and a localized necking and following fracture at plane stress condition. The system and method display the stretching failure risk in a unified SI representation with, for example, one-click operation by a technician. A technician can use the detected stretching failure risk for the practical application of altering the design of the die, part, stamping process plan, or any combination thereof and producing an associated die that transforms sheet metal blanks into stamp parts having the reduced stretching failure risk. Non-limiting examples of altering the design can include adjusting bead shapes or blank shapes and changing form feature on stamped part and thus allowing corresponding shape change on stamping die. It is contemplated that the method and system can include any number of other alterations to the design and the associated manufactured die and stamped part.

A processor generates computer simulations for the practical application of identifying and correcting issues with a design of a die, a part, and a stamping process plan prior to finalizing the design and using a die machining apparatus to build the die associated with the finalized design. To that end, techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions.

The current description relates to examples of methods and systems that employ steps and activities carried out by modules, including computers employing discrete rules and calculations, integrated into practical applications, such as the manufacture of physical articles. In this example, the method and system use one or more modules to transform tool materials into dies that produce stamped parts meeting sophisticated criteria. The practical applications of the current disclosure include elements that implement or use computer and/or mental activities in conjunction with particular and integral machines and manufactured articles. The specific machines employed, and the beneficial results achieved, are tangible and physical. The disclosed activities have practical utility and solve technological challenges. More specifically, in this example, the method and system use sheet metal forming simulation for applying an index threshold for multiple criteria and associated portions of stamped parts so as to provide a robust analysis of die design, reduce human error, and simplify stamping operations. Also, for example, the method and system can accurately produce higher quality dies and associated stamped parts, such that fewer hardware modifications are required.

The module may be implemented wholly, or partially, as a hardware circuit comprising discrete components. A module may also be implemented in programmable hardware devices, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together but may include disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set or may be distributed over different locations including over different storage devices, and may exist, at least partially, merely as electronic signals on a system or network.

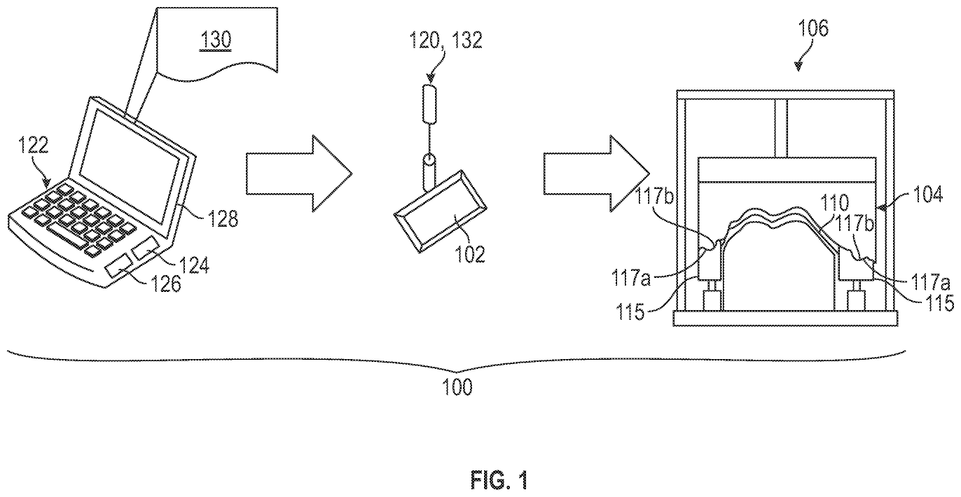

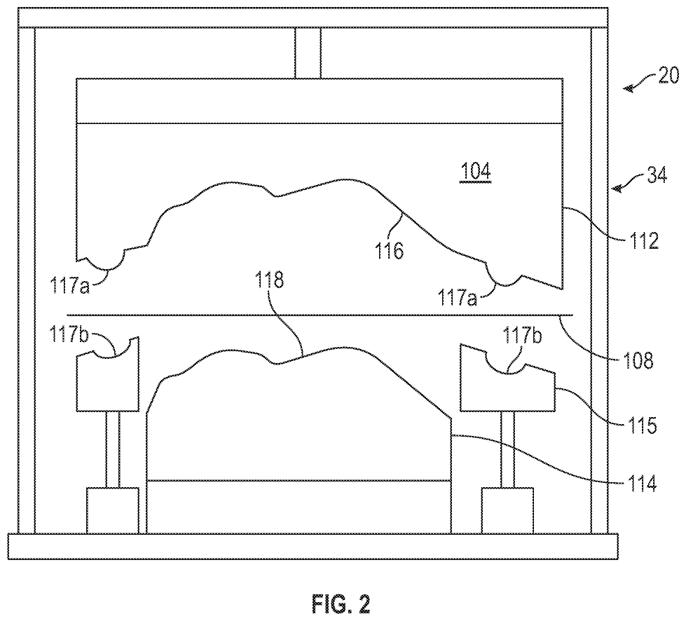

Referring now to FIGS. 1 and 2, a system 100 is provided for transforming a tool material 102 into a die 104 for a stamping machine 106, which is in turn configured to form a sheet metal blank 108 (FIG. 2) into a stamped part 110 of a motor vehicle. As best shown in FIG. 2, the die 104 includes an upper die half 112, a binder 115, and a lower die half 114 each fixed in the stamping machine 106. The die halves 112, 114 have respective complementary die surfaces 116, 118 facing one another. The upper die half 112 has a male bead 117a, and the binder 115 has a trough or recess 117b that is associated with the male bead 117a. The upper die half 112 is configured to move downward and clamp the sheet metal blank 108 with the binder 115. The upper die half 112 is configured to move further downward with the binder 115, which is supported by cushion pins to draw the sheet metal blank 108 flowing through the bead and into the die cavity between the die surfaces 116, 118. The die surfaces 116, 118 are configured to form the sheet metal blank 108 and change its shape into a workpiece that reflects the profile of the die surfaces 116, 118. In another example (not shown), the die can include the lower die half having a die cavity and a punch for drawing the sheet metal blank into the die cavity. The die 104 may be one in a series of dies through which the sheet metal blank is progressively processed to change the sheet metal blank into the shape of the finished product. Prior to building the die, simulation tools and 3-D math data of the finished stamped part to be produced is used to evaluate the design of the die, the stamped part, and the stamping process plan. This provides the ability to make any necessary correction in a computer simulation as compared to physical die, thus saving substantial time and expense.

In this example, the system 100 includes one or more computing devices 122 for generating simulations to identify and correct issues prior to finalizing die design and actuating the die manufacturing device 120 to build the die. The computing device 122 includes at least one processor 124, a processor-readable medium 126, and some form of input and output hardware. Program or code segments can be stored in the processor-readable medium 126 or transmitted by a computer data signal embodied in a carrier wave over a transmission medium or communication path. The “processor-readable medium”, “computer-readable medium”, or “machine-readable medium” may include any transitory or non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or any combination thereof. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The computing device 122 may be a standalone computer system, a portable computing device, or a personal computing device (e.g., a tablet computer, a laptop computer, a personal digital assistant (PDA), a smartphone), or the like. For purposes of the present disclosure, the computing device 122 is capable of storing, maintaining, and executing a program, code segments, or other instructions configured to evaluate aspects of stamping operations including dies using mesh data files. However, it is further contemplated that the processor can store other software tools that produce simulations without using mesh data models. In addition, the computing device 122 includes a display device 128 electrically coupled to the processor 124 for displaying visualizations 130, such as those of application pages, part surfaces, and die surfaces. Visualizations of part surfaces can include an indication or illustration of a part fracture.

In exemplary embodiments, the die manufacturing device 120 is configured to transform a tool material into the die 104. In this example, the die manufacturing device 120 is a computer numerically controlled machine 132 configured to conduct a material removal operation in response to the computer numerically controlled machine receiving the stretching acceptance signal from the processor. However, it is contemplated that the die manufacturing device can be other metal removal machines for building the die 104, which may in turn be used in the stamping machine 106 for producing the stamped part 110.

The processor 124 is configured to receive data for at least one of a die design, a part design, and a stamping process plan associated with the workpiece. The data associated with the part design can include a geometry of the stamped part and one or more material properties of the sheet metal forming the stamped part. It is contemplated that the data can include other suitable parameters of the finished stamped part to be produced.

The processor 124 is further configured to produce a computer simulation of the die 104 based on the data. The processor 124 can produce a computer simulation using software applications, such as computer aided design (CAD), stored on the processor-readable medium 126, in response to the processor 124 receiving the part data. The simulation of the die produces an associated simulated stamped part having a bead affect portion, a trimmed edge portion, and a plane stress portion.

The processor 124 is configured to address fracture and wrinkling, two major failures in sheet metal forming. In forming simulation analysis, the fracture risk may be analyzed by: 1) checking maximum failure through forming limit diagram (FLD): 2) checking thinning for inside plane elements; and 3) checking major strain for edge fracture. Then, wrinkling defect is detected by geometric based evaluation. Herein, a unified failure index tool is proposed to report both fracture and wrinkling in a single view. A binary decision algorithm realized as a function in a software application, such as AutoForm. As a result, the four step operation described above is automatically realized by one step. Thus, at least 75% efficiency improvement can be achieved.

As described herein, the unified failure index (UFI) represents the wrinkling index (WI) in the negative domain and the stretching failure index (SI) in the positive domain as below:

$$UFI = \{ \begin{matrix}SI = \{ \begin{matrix}max ( ( \frac{{ε}_{1}^{p} ( i )}{{ε}_{1}^{F} ( {ε}_{2}^{p} ( i ) )} , \frac{t {h}^{p} ( i )}{t {h}^{M} ( {ε}_{2}^{p} ( i ) )} ) , within sheet panel ( 1.1 ) \\ max ( ( \frac{{ε}_{1}^{p} ( i )}{{ε}_{1}^{F} ( {ε}_{2}^{p} ( i ) )} , \frac{t {h}^{p} ( i )}{t {h}^{M} ( {ε}_{2}^{p} ( i ) )} ) , on trimmed edge ( 1.2 )\end{matrix} \\ WI = - \frac{w}{{w}_{c}} , SI < 1 and SI < \vert WI \vert ( 1.3 )\end{matrix}$$

where, for each element, at operation p and time step (i), ε₁^{p}(i) is the major strain, ε₂^{p}(i) is the minor strain, ε₁^{F}(ε₂^{p}(i)) is the major strain limit along either linear strain path or non-linear strain path at corresponding minor strain ε₂^{p}(i), th^{p}(i) is the thinning, th^{M}(ε₂^{p}(i)) is the thinning limit as a function of minor strain ε₂^{p}(i).

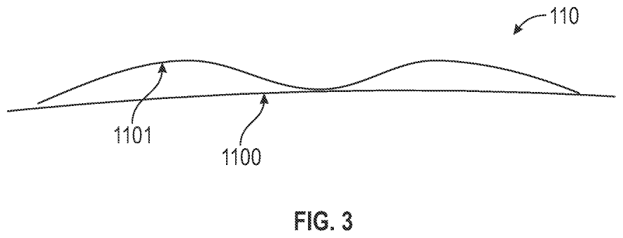

FIG. 3 illustrates a wrinkling risk calculation of a sheet 110. The wrinkling index (WI) is a negative ratio between w, representing the wrinkling risk, and w_{c}, which is a threshold value above which a wrinkling is reported. The wrinkling index (WI) may be determined through correlation with physical sheet metal panel in forming and simulation. As illustrated in FIG. 3, W is calculated by equation (2.1):

$$w = t ( \frac{1}{{R}_{S}} - \frac{1}{{R}_{T}} ) \qquad ( 2.1 )$$

where, t is the sheet thickness, Rₛ is the radius of sheet metal in forming, and R_{T} is the radius of tooling surface to be contacted. In FIG. 3, R_{T}, the radius of tooling surface to be contacted, is identified by reference number 1100, and Rₛ, the radius of sheet metal in forming, is identified by reference number 1101.

When the stretching index (SI) is less than 1 and the absolute value of the wrinkling index (WI) is greater than the SI, then the UFI is reported as the WI, otherwise, the UFI is equal to the SI. Since the WI is always a negative value while the SI is always a positive value, when UFI is positive, fracture risk is reported and the risk is proportional to the positive value; on the other hand, a negative UFI proportionally means a wrinkling risk.

Further embodiments herein provided for determining SI at a trimmed edge or at an interior location of the sheet metal.

First, a strain ratio-based method is provided to detect that the element under analysis is located on the trimmed edge of the sheet metal. Under an assumption of linear strain path at each operation, which is true for most stamping operation, for each element, the ratio between incremental minor strain and major strain at each time step i of operation p is calculated as below in equation (3.1):

$${ρ}^{p} ( i ) = \frac{d {ε}_{2}^{p} ( i )}{d {ε}_{1}^{p} ( i )} \qquad ( 3.1 )$$

where, dε₂^{p}(i) and dε₁^{p}(i) are incremental minor strain and major strain as in equation (3.2):

$$d {ε}_{j}^{p} ( i ) = {ε}_{j}^{p} ( i ) - {ε}_{j}^{p} ( 0 ) , j = 1 , 2 \qquad ( 3.2 )$$

Using the normal anisotropy parameter

$$\overline{r} = \frac{{r}_{0} + 2 {r}_{45} + {r}_{90}}{4} ,$$

under uniaxial tension, the critical strain ratio ρ^{u}, is about

$$\frac{- \overline{r}}{\overline{r} + 1} [ 2 ] .$$

The concerned element or element under analysis is regarded to be at a trimmed edge, when in equation (3.3):

$$0.9 {ρ}^{u} \leq {ρ}^{p} ( i ) \leq 1.1 {ρ}^{u} \qquad ( 3.3 )$$

This method can work with other method to determine the trimmed edge, for example checking if the element has a free edge.

Further embodiments provided herein may adjust for major strain under bead effect. Specifically, the major strain at a bead effect area can be adjusted: for example, by the method given in U.S. Patent Publication 2022/0100923A1, or Keeler S . . . “The Enhanced FLC Effect.” A report for Auto Steel Partnership. Keeler Technologies LLC. 2002, according to equation (4.1):

$${ε}_{1}^{p *} ( i ) = ln ( exp ( {ε}_{1}^{p} ( i ) ) + 0.6 {ε}_{t}^{p} ( i ) ) \qquad ( 4.1 )$$

where, ε₁^{p}(i) and εₜ^{p}(i) are the predicted major strain and thickness strain at time step (i) of operation p, which can be calculated under equation (4.2) as:

$${ε}_{t}^{p} = ln ( \frac{{t}_{i}}{{t}_{o}} ) . \qquad ( 4.2 )$$

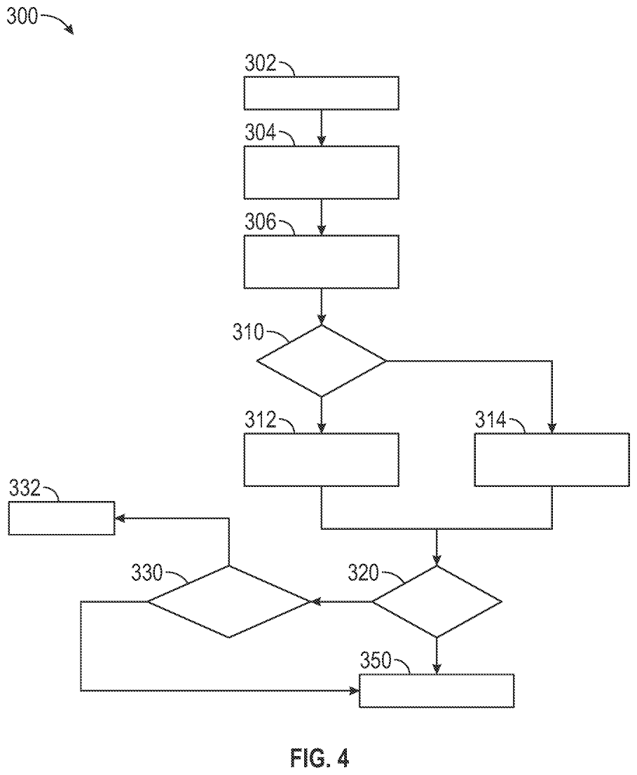

Referring to FIG. 4, an example of a method 300 of operating the system 100 of FIG. 1 is shown. The method 200 commences at block 302 with the processor 124 receiving data associated with the die design, the part design, the stamping process plan, or any combination thereof. In one example, the processor 124 receives data associated with the part design that includes at least one of a geometry of the stamped part and one or more material properties of the sheet metal of the stamped part.

At block 304, the processor 124 produces a computer simulation of the die 104, in response to the processor 124 receiving the data. In another example, the processor 124 produces an altered computer simulation of the die 104, in response to the processor 124 receiving altered data.

At block 306, the processor 124 determines a wrinkling index (WI) for panel. For example, the wrinkling index (WI) may be determined from the equation (1.3):

$$WI = - \frac{w}{{w}_{c}} , \qquad ( 1.3 )$$

where w is calculated by equation (2.1):

$$w = t ( \frac{1}{{R}_{S}} - \frac{1}{{R}_{T}} ) \qquad ( 2.1 )$$

where t is sheet thickness,
Rₛ is radius of sheet metal in forming,
R_{T} is radius of tooling surface to be contacted, and
w_{c} is a threshold value, less than which a wrinkling is reported, and can be determined through correlation with physical sheet metal panel in forming and simulation.

The method 300 continues at block 310 with the processor 124 querying whether the element under examination is on an edge of the workpiece. For example, the processor 124 may determine whether the element under examination is on an edge of the workpiece using the following equation (3.1):

$${ρ}^{p} ( i ) = \frac{d {ε}_{2}^{p} ( i )}{d {ε}_{1}^{p} ( i )} \qquad ( 3.1 )$$

Where, dε₂^{p}(i) and dε₁^{p}(i) are incremental minor strain and major strain in equation (3.2) as:

$$d {ε}_{j}^{p} ( i ) = {ε}_{j}^{p} ( i ) - {ε}_{j}^{p} ( 0 ) , j = 1 , 2 \qquad ( 3.2 )$$

Using the normal anisotropy parameter

$$\overline{r} = \frac{{r}_{0} + 2 {r}_{45} + {r}_{90}}{4} ,$$

under uniaxial tension, the critical strain ratio ρ^{u}, is about

$$\frac{- \overline{r}}{\overline{r} + 1} [ 2 ] .$$

Concerned element is regarded at trimmed edge, when in equation (3.3):

$$0.9 {ρ}^{u} \leq {ρ}^{p} ( i ) \leq 1.1 {ρ}^{u} \qquad ( 3.3 )$$

If the element is not on an edge, i.e., the element is within the sheet panel, then the method continues at block 312. At block 312, the processor 124 determines a stretching index (SI) for the element within the sheet panel. For example, the stretching index (SI) may be determined from the equation (1.1):

$$SI = max ( \frac{{ε}_{1}^{p} ( i )}{{ε}_{1}^{F} ( {ε}_{2}^{p} ( i ) )} , \frac{{th}^{p} ( i )}{{th}^{M} ( {ε}_{2}^{p} ( i ) )} ) , within sheet panel \qquad ( 1.1 )$$

where, for each element, at operation p and time step (i), ε₁^{p}(i) is the major strain, ε₂^{p}(i) is the minor strain, ε₁^{F}(ε₂^{p}(i)) is the major strain limit along either linear strain path or non-linear strain path at corresponding minor strain ε₂^{p}(i), th^{p} (i) is the thinning, th^{M} (ε₂^{p}(i)) is the thinning limit as a function of minor strain ε₂^{p}(i).

If the element is on an edge, then the method continues at block 314. At block 314, the processor 124 determines a stretching index (SI) for an element on a trimmed edge of the panel. For example, the stretching index (SI) may be determined from the equation (1.2):

$$SI = max ( \frac{{ε}_{1}^{p *} ( i )}{{ε}_{1}^{E}} , \frac{{ε}_{1}^{p} ( i )}{{ε}_{1}^{F} ( {ε}_{2}^{p} ( i ) )} , \frac{{th}^{p} ( i )}{{th}^{M} ( {ε}_{2}^{p} ( i ) )} ) , on trimmed edge \qquad ( 1.2 )$$

As shown, following the determination of the stretching index (SI) at block 312 or at block 314, the method continues at block 320 where the processor determines whether the stretching index (SI) is greater than or equal to 1.

If the stretching index (SI) is not greater than or equal to 1, then the method continues at block 330 where the processor determines if the stretching index (SI) is greater than or equal to the absolute value of the wrinkling index (WI). If the stretching index (SI) is not greater than or equal to the absolute value of the wrinkling index (WI), then the processor determines at block 332 that the Unified Failure Index equals the wrinkling index (WI) determined at block 306.

Referring back to block 320, if the processor determines that the stretching index (SI) is greater than or equal to 1, then the method 300 continues at block 350 where the processor determines that the Unified Failure Index equals the stretching index (SI) determined at block 312 or 314.

Referring back to block 330, if the processor determines that the stretching index (SI) is greater than or equal to the absolute value of the wrinkling index (WI), then the method 300 continues at block 350 where the processor determines that the Unified Failure Index equals the stretching index (SI) determined at block 312 or 314.

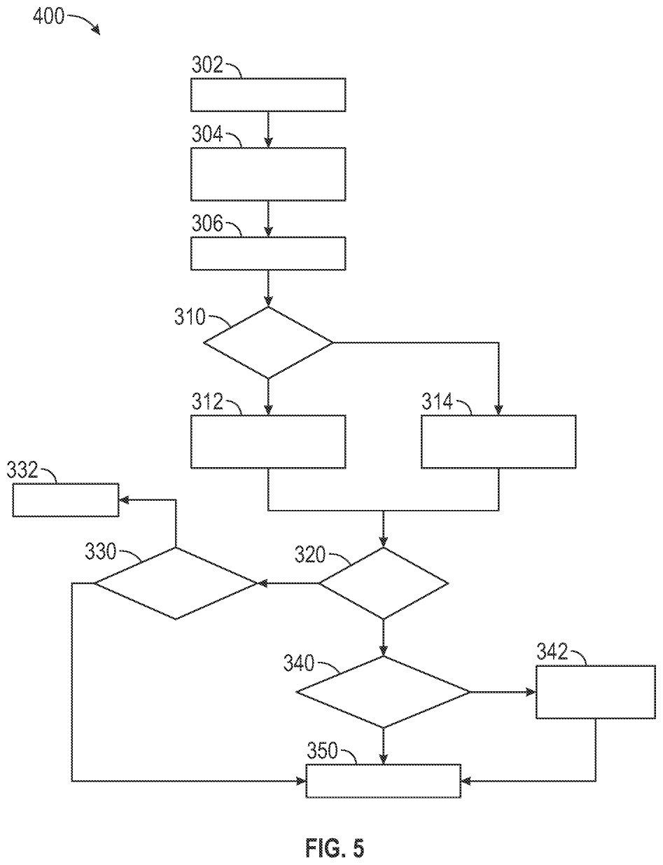

FIG. 5 illustrates a method 400 of operating the system 100 of FIG. 1. Method 400 is similar to method 300, from blocks 302 through 332. In method 400, when the processor determines that the stretching index (SI) is greater than or equal to 1, then the method 400 continues at block 340, where the processor determines if the element under examination is at a bead effect zone. If the element is not at a bead effect zone, then method 400 continues at block 350 where the processor determines that the Unified Failure Index equals the stretching index (SI) determined at block 312 or 314.

When the element is at a bead effect zone, the method 400 continues at block 342, wherein the processor adjusts the major strain at the bead effect zone and updates SI, according to equation (4.1):

$${ε}_{1}^{p *} ( i ) = ln ( exp ( {ε}_{1}^{p} ( i ) ) + 0.6 {ε}_{t}^{p} ( i ) ) \qquad ( 4.1 )$$

where, ε₁^{p}(i) and εₜ^{p}(i) are the predicted major strain and thickness strain at time step (i) of operation p, which can be calculated in equation (4.2) as

$${ε}_{t}^{p} = ln ( \frac{{t}_{i}}{{t}_{o}} ) . \qquad ( 4.2 )$$

where, tᵢ is the thickness of current time step (i) of operation p, and t₀ is the original thickness.

After the processor adjusts the major strain, method 400 continues at block 350, where the Unified Failure Index (UFI) equals the stretching failure index (SI), as updated at action block 342.

In certain embodiments, an algorithm is provided to realize the UFI in evaluating a simulation result. For each element at time step 1 of operation p, the algorithm loops through each element and executes the following steps:
(1) Start with checking if the element on the trimmed edge or not (block 310), if element is on the trimmed edge, then the SI will be calculated by Eq. (1.2) (block 314), otherwise, the SI is calculated by Eq. (1.1) (block 312).
(2) Check if SI≥1 (block 320) if yes, goto step 3, if no goto step 6;
(3) Check if element under analysis is at bead affect zone (block 340), if yes goto step 4, if no goto step 5;
(4) Correct bead effect by Eq. (4.1) and update SI (block 342) then goto step 5;
(5) UFI=SI (block 350)
(6) Check if |WI|>SI, i.e., the absolute of the WI value is greater than SI (block 330), if yes goto step 7: Else, goto step 5;
(7) UFI=WI (block 332).

As described above, method 300 and method 400 each provide an algorithm for processing a unified failure index tool. In each of these methods, both the stretching failure index (SI) and the wrinkling index (WI) is considered in determining the Unified Failure Index (UFI). These methods provide an efficient process for evaluating failures. A conventional process utilizing five steps may be reduced to a single click to activate a script-enabled automated process.

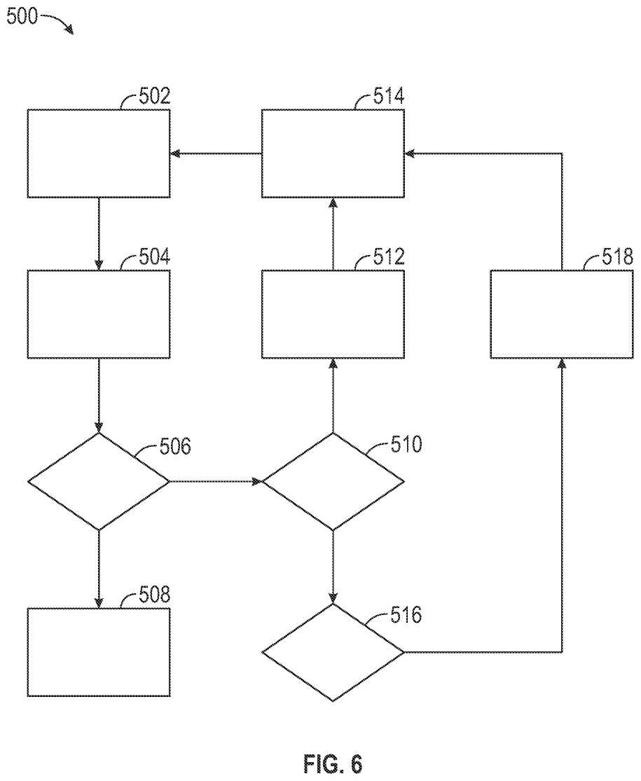

FIG. 6 illustrates a method 500 of using a Unified Failure Index (UFI) to optimize a stamping process. As shown, method 500 commences at block 502 with the processor 124 running a forming simulation to form a simulated sheet. Further, at block 504, the processor 124 reads the UFI and then queries, at block 506, whether the absolute value of the UFI is greater than or equal to 1 (|UFI|≥1) at any locations on the simulated sheet. If no, then the method proceeds to block 508, at which the method 500 indicates that he simulated sheet passes the formability analysis.

If it is determined at block 506 that the absolute value of the UFI is greater than or equal to 1 (|UFI|≥1) at locations on the simulated sheet, then method 500 proceeds to block 510, which queries whether UFI is greater than or equal to 1 (UFI≥1). If yes, then the method 500 proceeds to block 512, where the method addresses the fracture risk. If no, then the method 500 proceeds to block 516, which queries whether UFI is less than or equal to −1 (UFI≤−1). If yes, then the method 500 proceeds to block 518, where the method addresses the wrinkling risk.

After the fracture risk (at block 512) or wrinkling risk (at block 518) is addressed, the method 500 proceeds at block 514 with updating the process before repeating the method at block 502.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for analyzing a stamped part that has a final shape for a motor vehicle, the method comprising:
receiving, using the processor, data for the stamped part;
producing, using the processor, a computer simulation based on the data;
determining, using the processor, a wrinkling index (WI) for the stamped part in response to the processor producing the computer simulation;
determining, using the processor, whether an element under analysis is located at a trimmed edge of the stamped part;
when the element under analysis is located at a trimmed edge of the stamped part, determining, using the processor, a stretching index (SI) for a trimmed edge portion in response to the processor producing the computer simulation, or when the element under analysis is not located at a trimmed edge of the stamped part, determining, using the processor, a SI for a plane stress portion in response to the processor producing the computer simulation;
comparing the SI to a SI threshold and/or comparing the SI to the WI; and
generating, using the processor, a uniform failure index (UFI) equal to the SI in response to the processor determining that the SI is greater than the SI threshold, a UFI equal to the SI in response to the processor determining that the SI index is less than the SI threshold and is greater than the absolute value of the WI, and a UFI equal to the WI in response to the processor determining that the SI is less than SI threshold and is less than the absolute value of the WI.

2. The method of claim 1, further comprising:
generating, using the processor, a stretching failure signal in response to the processor determining that the SI is greater than the SI threshold; and
indicating, using the display device, that the stamped part has a fracture in response to the display device receiving the stretching failure signal.

3. The method of claim 1, further comprising:
generating, using the processor, a wrinkling failure signal in response to the processor determining that the WI is less than a WI threshold; and
indicating, using the display device, that the stamped part has a wrinkle in response to the display device receiving the wrinkling failure signal.

4. The method of claim 1, further comprising:
generating, using the processor, a stretching failure signal in response to the processor determining that the SI is greater than the SI threshold;
generating, using the processor, a wrinkling failure signal in response to the processor determining that the WI is less than a WI threshold; and
indicating, using the display device, that the stamped part has a fracture in response to the display device receiving the stretching failure signal and that the stamped part has a wrinkle in response to the display device receiving the wrinkling failure signal.

5. The method of claim 4, wherein the SI threshold is 1 and wherein the WI threshold is −1.

6. The method of claim 1, wherein determining, using the processor, whether the element under analysis is located at a trimmed edge of the stamped part, assumes a linear strain path at each operation, and calculates, for each element, a ratio between incremental minor strain and major strain at each time step i of operation p according to equation (2.1):
$${ρ}^{p} ( i ) = \frac{d {ε}_{2}^{p} ( i )}{d {ε}_{1}^{p} ( i )} \qquad ( 2.1 )$$
where, dε₂^{p}(i) and dε₁^{p}(i) are incremental minor strain and major strain according to equation (2.2):
$$d {ε}_{j}^{p} ( i ) = {ε}_{j}^{p} ( i ) - {ε}_{j}^{p} ( 0 ) , j = 1 , 2 \qquad ( 2.2 )$$
where, in a normal anisotropy parameter
$$\overline{r} = \frac{{r}_{0} + 2 {r}_{45} + {r}_{90}}{4} ,$$
under uniaxial tension, the critical
$$\frac{- \overline{r}}{\overline{r} + 1} [ 2 ] ,$$
strain ratio ρ^{u}, is about such that the element under analysis is determined to be at a trimmed edge of the stamped part according to equation (2.3):
$$0.9 {ρ}^{u} \leq {ρ}^{p} ( i ) \leq 1.1 {ρ}^{u} . \qquad ( 2.3 )$$

7. The method of claim 1, wherein determining, using the processor, a SI for a trimmed edge portion in response to the processor producing the computer simulation comprises determining a maximum SI from a plurality of stretching indices.

8. The method of claim 1, wherein determining, using the processor, a SI for a plane stress portion in response to the processor producing the computer simulation comprises determining the SI from the equation (1.1):
$$SI = max ( \frac{{ε}_{1}^{p} ( i )}{{ε}_{1}^{F} ( {ε}_{2}^{p} ( i ) )} , \frac{{th}^{p} ( i )}{{th}^{M} ( {ε}_{2}^{p} ( i ) )} ) , within sheet panel . \qquad ( 1.1 )$$

9. The method of claim 1, wherein determining, using the processor, a SI for a trimmed edge portion in response to the processor producing the computer simulation comprises determining the SI from the equation (1.2):
$$SI = max ( \frac{{ε}_{1}^{p *} ( i )}{{ε}_{1}^{E}} , \frac{{ε}_{1}^{p} ( i )}{{ε}_{1}^{F} ( {ε}_{2}^{p} ( i ) )} , \frac{{th}^{p} ( i )}{{th}^{M} ( {ε}_{2}^{p} ( i ) )} ) , on trimmed edge . \qquad ( 1.2 )$$

10. The method of claim 1, wherein determining, using the processor, a SI for a plane stress portion in response to the processor producing the computer simulation comprises determining a maximum SI from a plurality of stretching indices (SIs).

11. The method of claim 1, wherein determining, using the processor, the WI for the stamped part in response to the processor producing the computer simulation comprises determining the WI from the equation (1.3):
$$WI = - \frac{w}{{w}_{C}} . \qquad ( 1.3 )$$

12. The method of claim 1, further comprising displaying visual indications of the stretching indices (SIs) and wrinkling indices (WIs) associated with the computer simulation.

13. A system for analyzing a stamped part that has a final shape for a motor vehicle, the system comprising:
a processor configured to:
receive, data for the stamped part;
produce a computer simulation based on the data:
determine a wrinkling index for the stamped part in response to the processor producing the computer simulation;
determine whether an element under analysis is located at a trimmed edge of the stamped part:
determine a stretching index (SI) for a trimmed edge portion when the element under analysis is located at a trimmed edge of the stamped part;
determine a SI for a plane stress portion when the element under analysis is not located at a trimmed edge of the stamped part;
compare the SI to a SI threshold and/or compare the SI to the WI; and
generate a UFI equal to the SI in response to determining that the SI is greater than the index threshold, generate a UFI equal to the SI in response to determining that the SI is not greater than the SI threshold and is greater than the absolute value of the WI, or generate a UFI equal to the WI in response to determining that the SI is not greater than the SI threshold and is not greater than the absolute value of the WI; and
a display device electrically coupled to the processor and configured to visually indicate the SIs and the WIs associated with the computer simulation.

14. The system of claim 13, wherein:
the processor is configured to generate a stretching failure signal in response to determining that the SI is greater than the SI threshold; and
the display device is configured to indicate the stamped part has a fracture in response to the display device receiving the stretching failure signal.

15. The system of claim 13, wherein:
the processor is configured to generate a wrinkling failure signal in response to the processor determining that the WI is less than a WI threshold; and
the display device is configured to indicate the stamped part has a wrinkle in response to the display device receiving the wrinkling failure signal.

16. The method of claim 13, wherein:
the processor is configured to generate a stretching failure signal in response to determining that the SI is greater than the SI threshold;
the processor is configured to generate a wrinkling failure signal in response to the processor determining that the WI is less than a WI threshold;
the display device is configured to indicate the stamped part has a fracture in response to the display device receiving the stretching failure signal; and
the display device is configured to indicate the stamped part has a wrinkle in response to the display device receiving the wrinkling failure signal.

17. A system for producing a die configured to form a sheet metal blank into a workpiece for a stamped part that has a final shape for a motor vehicle, with the workpiece having a bead affect portion, a trimmed edge portion, and a plane stress portion, the system comprising:
a processor configured to:
receive data for at least one of a die design, a part design, and a stamping process plan associated with the workpiece;
produce a computer simulation based on the data;
determine a stretching index (SI) for an associated one of the bead affect portion, the trimmed edge portion, and the plane stress portion of the workpiece in response to the processor producing the computer simulation;
compare the SI for each of the bead affect portion, the trimmed edge portion, and the plane stress portion to an SI threshold; and
generate a stretching failure signal in response to the processor determining that the SI for at least one of the bead affect portion, the trimmed edge portion, and the plane stress portion is greater than the SI threshold;
determine a wrinkling index for the workpiece in response to the processor producing the computer simulation;
compare the WI to a WI threshold; and
generate a wrinkling failure signal in response to the processor determining that the WI is less than the WI threshold;
receive altered data for at least one of an altered die design, an altered part design, and an altered stamping process plan associated with the workpiece;
produce an altered computer simulation based on the altered data;
determine an altered SI for an associated one of the bead affect portion, the trimmed edge portion, and the plane stress portion of the workpiece in response to the processor producing the altered computer simulation; and
generate a stretching acceptance signal in response to the processor determining that one of the SI and the altered SI for each of the bead affect portion, the trimmed edge portion, and the plane stress portion is not greater than the SI threshold;
determine an WI for the workpiece in response to the processor producing the altered computer simulation; and
generate a wrinkling acceptance signal in response to the processor determining that one of the WI and the altered WI is less than the WI threshold; and
a display device electrically coupled to the processor and configured to:
indicate that the workpiece has a fracture and/or a wrinkle and to prompt a user to input the altered data into the processor, in response to the display device receiving the stretching failure signal and/or the wrinkling failure signal;
indicate that the workpiece does not have the fracture and/or the wrinkle in response to the display device receiving the stretching acceptance signal and/or the wrinkling acceptance signal, such that the processor sends the stretching acceptance signal and/or the wrinkling acceptance signal to a die manufacturing device for transforming a tool material into the die associated with one of the SI and the altered SI that is less than the SI threshold and with one of the WI and the altered WI that is greater than the WI threshold.

18. The system of claim 17 wherein the processor is configured to receive the data associated with the part design, with the data comprising at least one of a geometry of the stamped part and at least one material property of the sheet metal forming the stamped part.

19. The system of claim 17 wherein the processor is configured to generate a bead affect stretching failure signal in response to the processor determining that the SI of the bead affect portion is greater than the SI threshold, and the display device indicates that the fracture is disposed in the bead affect portion in response to the display device receiving the bead affect stretching failure signal from the processor.

20. The system of claim 17 wherein the processor is configured to generate a trimmed edge stretching failure signal in response to the processor determining that the SI of the trimmed edge portion is greater than the SI threshold, and the display device indicates that the fracture is disposed in the trimmed edge portion in response to the display device receiving the trimmed edge stretching failure signal from the processor.
